(19) United States
(12) Patent Application Publication
(10) Pub. No.: US 2002/0032906 A1
(43) Pub. Date: Mar. 14, 2002

(54) Interactive marketing and advertising system and method

(76) Inventor: Avram S. Grossman, Irvine, CA (US)

Correspondence Address: Brian M. Berliner, O'MELVENY & MYERS LLP, 400 South Hope Street, Los Angeles, CA, 90071-2899, US

(21) Appl. No.: 09/872,921

(22) Filed: Jun. 2, 2001

Related U.S. Application Data
(60) Provisional application No. 60/209,081, filed on Jun. 2, 2000.

(51) Int. Cl. G06F 3/00; H04N 5/445; H04N 7/025; H04N 7/10; G06F 13/00; H04N 7/16

(52) U.S. Cl. 725/42; 725/32; 725/35; 725/46; 725/9

(57) ABSTRACT

An information delivery system is adapted to selectively deliver information to a viewer across a bi-directional, digital communications link. The information delivery system delivers, as its primary content, video commercials and infomercials of various lengths to an Internet device. Each commercial presented to the viewer may be “packaged” with any one of a number of promotional activities, data gathering activities or programs as selected by the advertiser. Each time a viewer watches a commercial and complies with other advertiser directed activities the viewer may be rewarded immediately with prizes and/or with one or more points that are accumulated in the viewer's account. The data from the viewers'profiles and responses are compiled to provide real-time information relating to the effectiveness of the commercial. The profile data may also be used for statistical tracking of consumer patterns and trends.

### BACKGROUND OF THE INVENTION

1. Field of the Invention

The present invention relates generally to interactive marketing and advertising systems and methods and, in particular, to a system and method for selectively delivering interactive promotional material.

2. Description of the Related Art

With the goal of positively effecting consumer and customer (“consumers”) relationships with their brands, products and services (“brands”), advertisers currently use a variety of techniques and media. The techniques and media include combinations of television broadcast, cable and radio advertising, for both commercial length and infomercial length messages, print advertising, direct response marketing, including direct mail, catalog and direct response print advertising, outdoor, transportation and new media based advertising and promotion including static and animated banners, windows, buttons, badges, interstitial advertising and email direct marketing.

The consumer of a brand's successful advertising and promotion goes through some predictable increments toward, and eventually resulting in, purchase and usage behavior. These increments of a consumer's progress include product category awareness, intention to try category, brand awareness, brand recognition, brand recall, brand trial, brand re-trial, and finally assessment and acceptance of brand, within the choice set either exclusively or within a limited set, resulting in purchase and usage.

Some steps in the consumer's incremental relationship building with the brand are prompted by advertiser promotion (defined as more interactive response oriented messages and techniques including calls to action) versus the more image and brand building advertising messages.

Conventional and new media environments, in which advertising and promotion exist, are cluttered with a variety of commercial messages along with programming or content, which the media contends is the primary driver of consumer attention to the media at any given point in time. The proliferation of television broadcast and cable channels and the ready access of channel changing by the viewer with a remote control, effectively work against advertisers having access to consumers for commercial messages that support, and effectively interrupt such programming.

Conventional media generally takes action for its programming, but not its commercials, to be measured by independent firms for a variety of factors including gross and segmented determinations of household viewing, readership or subscription, including geographical, demographic, as well as lifestyle characteristics including purchasing behavior and intention. The measurement in conventional broadcast media is based on sampling of households watching the programming. This sampling is used to project the universe of audience share and generally determines rates of compensation charged for commercial time that interrupts programming or content. For example, commercial time during a “highly rated” prime time program costs significantly more for an advertiser than “lower rated” programs at prime time or programs in less valuable time periods. There is no accounting for the loss or absence of the program's actual viewers during the time period that commercials air, which is typified by channel surfing or taking care of personal needs. In addition, new technology has become available that allows the viewer to record and, during playback, skip the commercials to easily avoid watching the commercials.

In new media, efforts are generally made to audit and report the gross, segmented and unique individual activity on a website including length of stay, attention to editorial content, requests for information and consumer activity related to banners, buttons, badges, and other “click” sensitive graphics or text.

The current advertising and promotion media and techniques are providing flawed channels of communication, response mechanisms and data collection and reporting for advertisers. There exists a need for an improved system and method for tracking the number of actual viewers of a commercial and measuring the effectiveness of the commercial. In addition, there exists a need for a system and method that encourages consumers to view the commercials.

### SUMMARY OF THE INVENTION

The present invention provides a system and method that combines otherwise separate component functions and methodologies used in conventional advertising, marketing and consumer data tracking practices, and integrates them along with new functions and methodologies into an entertaining, interactive environment that provides advantages to the advertiser and viewer or consumer.

In a preferred embodiment, an information delivery system is adapted to selectively deliver information to a viewer across a bi-directional, digital communications link. The information delivery system preferably delivers, as its primary content, video commercials and infomercials of various lengths to an Internet device. Each commercial presented to the viewer may be “packaged” with any one of a number of promotional activities, data gathering activities or programs as selected by the advertiser. Each time a viewer watches a commercial and complies with other advertiser directed activities the viewer may be rewarded immediately with prizes and/or with one or more points that are accumulated in the viewer's account. The data from the viewers'profiles and responses are compiled to provide real-time information relating to the effectiveness of the commercial. The profile data may also be used for statistical tracking of consumer patterns and trends.

The advertisers are provided with a cost-effective system to target commercials to viewers who have an interest in viewing the commercials and meet certain demographic and characteristic restrictions, and to measure the effectiveness of the commercial and its message on each individual viewer.

A more complete understanding of the Interactive Marketing and Advertising System and Method will be afforded to those skilled in the art, as well as a realization of additional advantages and objects thereof, by a consideration of the following detailed description of the preferred embodiment. Reference will be made to the appended sheets of drawings that will first be described briefly.

### BRIEF DESCRIPTION OF THE DRAWINGS

FIG. 1 is a diagram depicting the components of an interactive delivery system in a preferred embodiment of the present invention, including three types of access to the system and preferred functions provided to each access type;

FIG. 2 is a flow chart depicting a preferred process of selecting a “channel” to watch and other navigational pathways through a system website;

FIG. 3 is a flow chart describing a preferred construction of a web page “channel” to display;

FIG. 4 is a flow chart detailing preferred options a viewer is presented for redeeming rewards points;

FIG. 5 is a schematic representation of a preferred database table architecture that depicts the type of information that may be stored and retrieved relative to each type of data;

FIG. 6 is a pictorial diagram depicting the architecture of the computer system in accordance with a preferred embodiment of the present invention; and

FIG. 7 is an illustration of a preferred web page layout.

### DESCRIPTION OF PREFERRED EMBODIMENTS

In the detailed description that follows, like element numerals are used to describe like elements illustrated in one or more of the aforementioned figures.

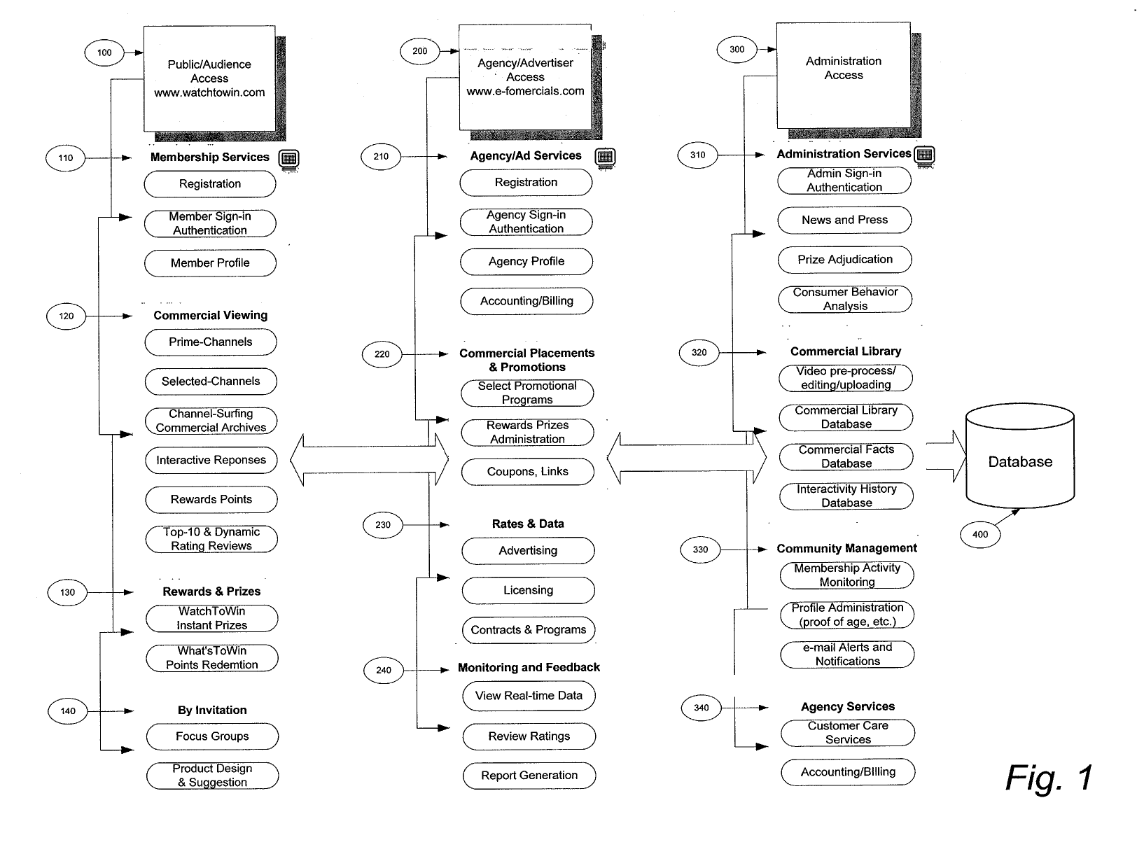

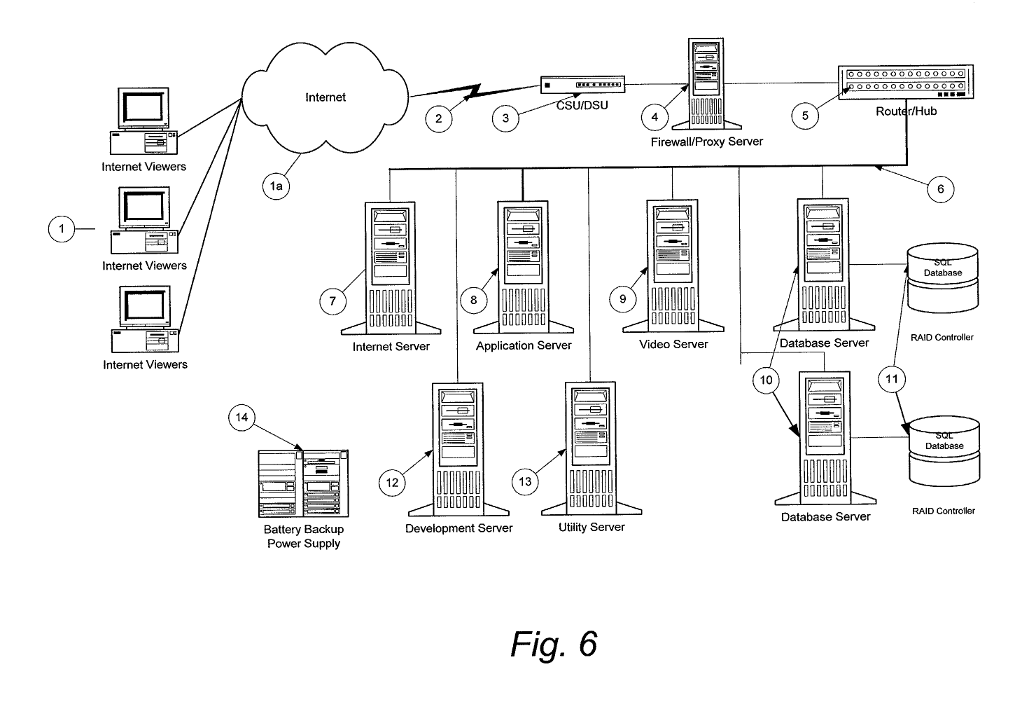

Referring first to FIG. 1, a preferred embodiment of an interactive delivery system is provided. The system provides a networked environment for each type of user of the system, including a public audience 100, agencies and advertisers 200, and one or more administrators 300. Certain interactions between the users and the system are recorded in a relational database 400. The relational database 400 includes at least one database server 10 (see FIG. 6), executing relational database management software.

A preferred embodiment of the system will now be described with reference to FIG. 6. The public audience includes viewers who operate network devices 1 such as computers, Wireless Application Protocol (WAP) devices, cable set top boxes, Internet appliances, satellite television systems or other devices that are adapted for bidirectional digital communications. Preferably, the network devices 1 provide the viewer with access to the Internet 1 a through web browser software. Through the Internet la, the Internet viewers may access an Internet server 7, which may be connected to the Internet I a through a channel service unit/data service unit 3, a firewall 4 and a local area network 5. The Internet server 7 is preferably a web server that stores web pages and provides World Wide Web services to the Internet viewers. The local area network 5 may also include an application server 8, a video server 9, the database server 10, one or more storage devices 11, a development server 12, a utility server 13 and a backup power supply 14. It should be apparent that the servers of the preferred embodiment may be implemented on any number of hardware devices and may be distributed across various locations.

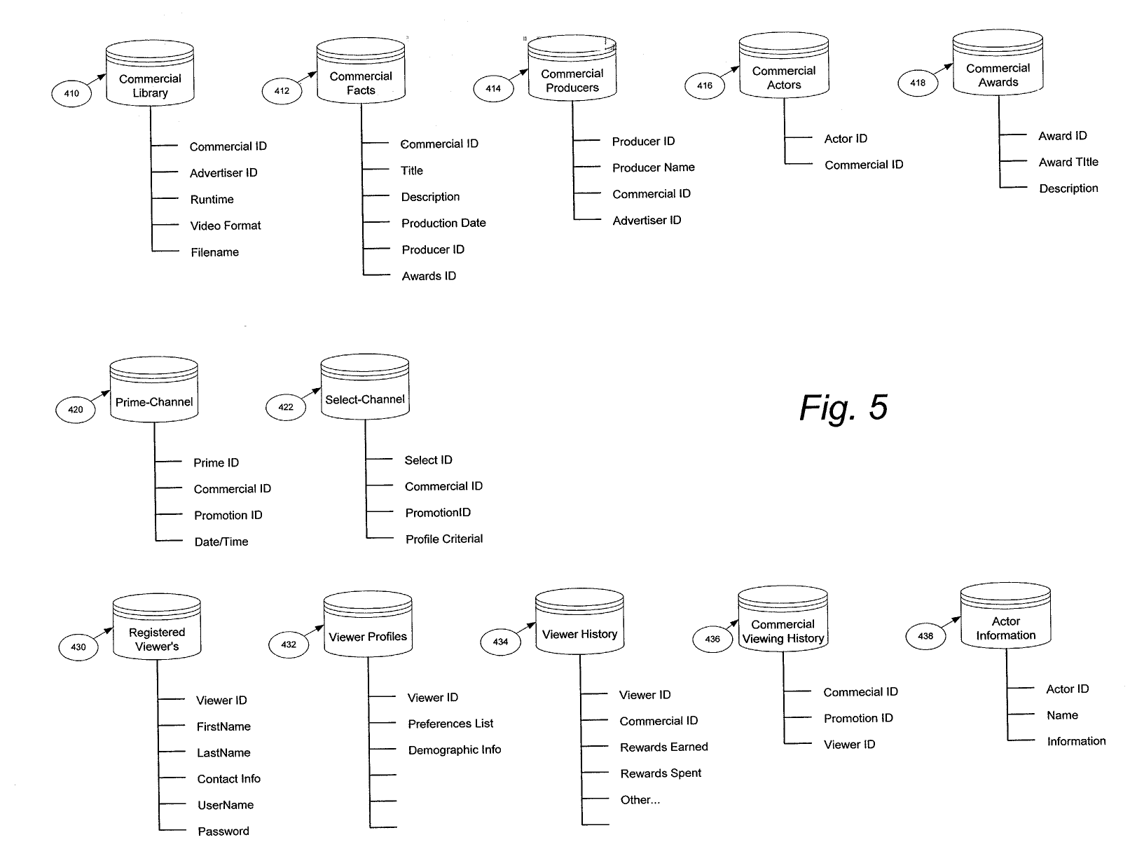

In operation, an Internet viewer may connect to the Internet server 7 to access and interact with web pages and retrieve other data stored in the storage device 11. The web browser used by the Internet viewer may be any one of a number of brands or versions, such as those made available by Microsoft's Internet Explorer® or Netscape Navigator®. The web pages delivered to the Internet viewer may be derived through HTML web pages that have been generated by a combination of HTML, Active Server Page (“ASP”), Java, or executable server programs in response to the Viewers selection, and based on specific criteria stored in their profile. The relational database content itself includes a number of database tables storing data such as detailed information about each viewer, each commercial, the interactions made by each viewer in response to viewing a commercial, and may contain the streaming video commercial content. In a preferred embodiment, the relational database includes the tables illustrated in FIG. 5, including commercial library 410, commercial facts 412, commercial producers 414, commercial actors 416, commercial awards 418, prime-channel 420, select-channel 422, registered viewers 430, viewer profiles 432, viewer history 434, commercial viewing history 436 and actor information 438.

Advertisers and advertising agencies (hereinafter “advertisers”) may also connect to the Internet server 7 through the Internet la. Video commercials and other promotional materials are stored by the advertisers in the storage device 11 and may be accessed by Internet viewers through the Internet server 7 and the video server 9. In a preferred embodiment, each video is compressed using standard video compression techniques.

Public Audience/Internet Viewer Functions

An individual viewer may interact with the system either as an anonymous guest or as a registered viewer. In the preferred embodiment anonymous viewers are not eligible to earn rewards points or win a prize (discussed further below), thus encouraging viewers to register. Referring back to FIG. 1, the membership services component 110 presents each viewer with one or more web pages that query the user for personal demographic information that will be stored as a viewer profile. After an individual is registered with the system, viewer may sign-in to the site through a username and password. In the preferred embodiment, the sign-in process uses a standard browser “cookie” method of identifying the return of the viewer, if the viewer has enabled cookies on its browser.

Once signed into the system, the viewer may view and interact with commercials and promotions 120 submitted by the advertisers, win prizes or qualify for giveaways while watching a commercial, earn and accumulate rewards points and exchange rewards points for prizes 130, and earn eligibility to participate in special “by invitation only” activities 140, such as focus groups.

Commercial Viewing Process

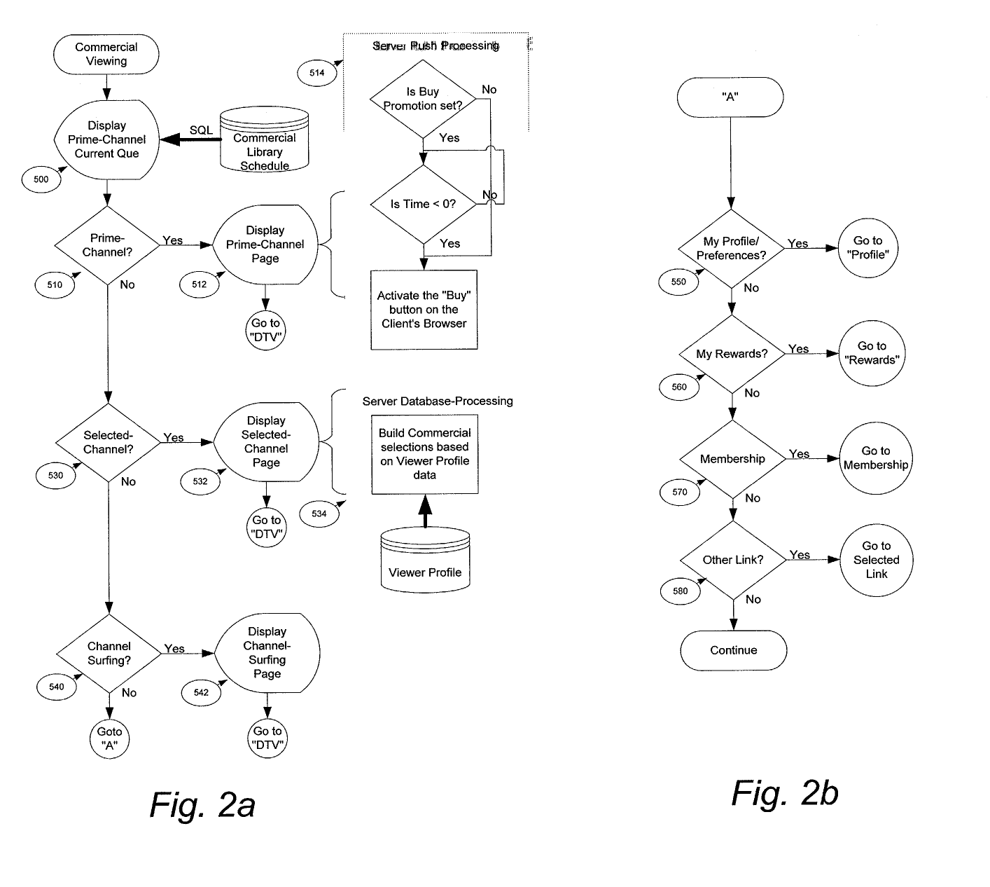

FIG. 2a is a flowchart illustrating the preferred interaction between the viewer and the system. When the viewer accesses the system through the Internet 1a, a homepage from the Internet server 7 is transferred to the viewer's web browser. The viewer may then select a “channel” or other web page link provided on the homepage. The homepage includes server-side program controls and data pulled from the database 400 based on an SQL query specific for the viewer. The viewer is identified based on a unique viewer ID code that was assigned to the viewer when the viewer registered (110) and data may be gathered based on the viewer's stored profile. The homepage may also present the viewer with a schedule of upcoming events and a list of the most popular commercials.

In a preferred embodiment, the viewer is provided with at least three channel options (step 500): a prime-channel, a selected-channel and channel surfing, along with a listing of selected commercials from each channel. The content on the prime-channel includes commercials providing special offers, sweepstakes, coupons, discounted prices, or other incentives based on a specific time-slot. In the preferred embodiment, the prime-channel displays all advertising matter to the viewer, with the exception of material with certain demographic restrictions (e.g., alcohol commercials may be limited to viewers who are over the age of 21). The content on the selected-channel includes commercials providing special offers, sweepstakes, coupons and discounted prices, or other incentives based on selected demographic criteria of the viewer. In a preferred embodiment, the viewer may select the criteria for commercials they would like to be exposed to. For example, a viewer may select “Sports/Golf Equipment” and “Vacations” but not chose not to view “Fast Food” commercials. The content under the channel-surfing option includes commercials from advertisers who wish to promote their brand name, and/or provide viewers with an archive of past commercials, for entertainment purposes.

When the viewer selects the link to “Prime-Channel” (step 510), Prime-Channel web page information is constructed (512) from the Prime-channel database table 420 using SQL queries specific to that viewer's time zone, age demographic and other profile information, which would influence the presentation of material to that viewer. “Prime-Channel” commercials are designed to contain a number of interactive promotional activities, of which some are time-scheduled. For example, one such time-scheduled activity is the “buy” or “on sale” function. The advertiser may select the type of promotional program to be presented using the Commercial Placements and Promotions function 220. One parameter of the promotion selection is the specification of date and time of day that the viewer may purchase an item, and optionally, to specify the number of items available for sale during this promotion. The purpose is to permit an advertiser to place a limited number of promotional items on sale on a first-buyer-first-sold basis only while a promotional commercial is presented.

Using server push-processing technology 514, the “buy” or “on sale” button on the viewer's browser may be activated. At the scheduled date and time-of-day, an electronic message is sent to all viewer's who are watching that particular promotion. The message enables the “buy” button, allowing the viewer to then press the “buy” button to effect a purchase request. In a preferred embodiment, the mechanism that enables the “buy” button incorporates a Java-compiled program that is uploaded to the viewer's browser along with other web page content. This Java program then responds to the incoming message and enables the button, which is effected as a browser “object.” Similarly, a “quantity remaining” indicator that functions in cooperation with the “buy” button may be provided. When the advertiser selects the option of placing a quantity limit on a promotional sale (component 220) and when the scheduled date and time-of-day is active, the number of units remaining for sale is “pushed” to the viewer's browser and updated each time the number of units remaining is decrements as a result of a “buy” activity. When the number of remaining units reaches zero, the “buy” button on the viewer's browser is subsequently disabled. When the streaming video commercial begins to play, and when it completes, special messaging signals are sent from the viewer's browser to the application server 9 (see FIG. 6). This process is explained below and may be used with any channel type.

When the viewer selects the link to “Selected-Channel” (step 530) the viewer is presented only those commercials that comply with the viewer's profile characteristics, and that also match the demographic requirements of the advertiser (532 and 534). For example, if a viewer is over the age of 21 and the viewer has indicated his or her interest in viewing commercials for tobacco products, and if the advertiser has set a demographic requirement that the viewer be over 21 years of age, then and only then will the viewer be able to see such commercials. Further, the commercial will be presented to the viewer only if that tobacco advertiser's promotional campaign specifically matches other demographic restrictions, such as a requirement that the viewer reside in an Eastern United States time zone. When the viewer selects the link to Selected-Channels 530, the web page information is constructed from a selected-channels database 422 (see FIG. 5) using SQL queries that match the viewer's demographics and other profile information 432 which influences the selection and presentation of material to that viewer.

When the viewer selects the link to “Surf-Channels” (step 540) the viewer is presented with the ability to view stored commercials and infomercials that are not restricted due to demographic or other viewing restrictions 542. A search engine permits the viewer to locate commercials based on a number of search parameters, such as by actor, by agency, by title, by advertiser, by keyword, and other searchable data.

Other Viewer Options

As illustrated in FIG. 2b, the homepage may also provide the viewer with links to view/edit the viewer's personal profile (550), view accumulated rewards points and redeem prizes (560), view/edit membership information (570) and other links (580).

Display of Commercials

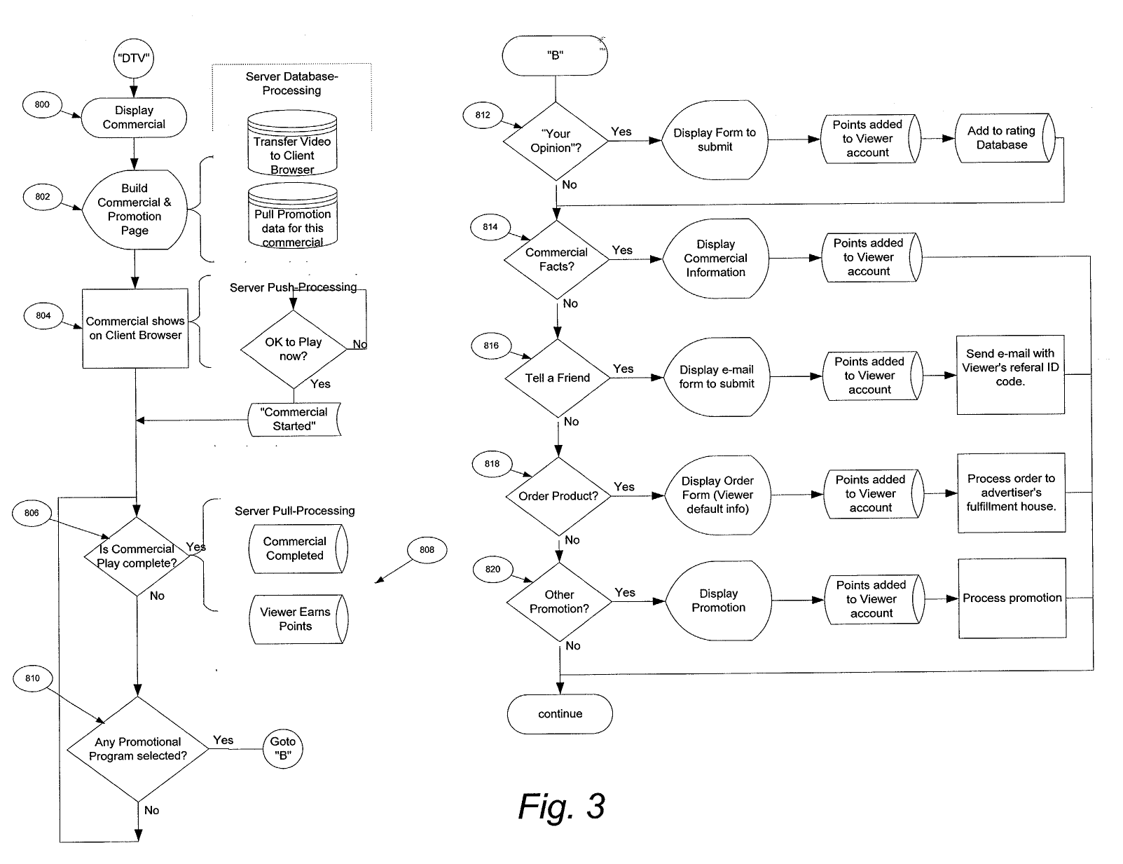

The display of selected commercials will now be described with reference to the flow diagram of FIG. 3. In a preferred embodiment, the viewer earns rewards points when a viewed commercial concludes. The number of points earned may be different for each commercial, and may be different based on a number of other factors, such as the number of times the same commercial is viewed by the viewer, or if the commercial was viewed during a “Prime-channel” or “Selected-channel” event. Several video compression and delivery methods may be incorporated into the system, such as Real Producer's “Real Player” that uses the “Real Video Server” delivery method, or Microsoft's “Media Player” using the “MS-Media Server.” When a commercial is selected, the video format specified to use from the viewer's profile 432 is selected from the commercial library database (410) and delivered using the appropriate video server technology.

After the viewer instructs the system to display a commercial (step 800), the system builds a commercial and promotion page based from stored promotion data and downloads the page to the viewer's web browser (step 802). The commercial is then played on the viewer's Internet device (step 804). The system tracks the playing of the streamed commercial on the user's computer (step 806) and adds rewards points associated with the video to the viewer's account when the system has confirmation that the commercial has been completely played on the viewer's Internet device (step 808). If promotional programs are also selected, then each promotional program is played on the viewer's Internet device (step 810) and the viewer receives additional rewards points for each promotion completed by the viewer.

In a preferred embodiment, the viewer may be provided with the opportunity to rate and review the viewed commercial (step 812), in which case a survey form will be downloaded to the web browser and the viewer will receive rewards points when the completed survey is submitted to the system. The completed survey data is stored in a ratings database that may be queried by the advertiser, providing the advertiser with immediate feedback concerning the commercial. The viewer may also receive additional rewards points for viewing commercial facts (step 814), for e-mailing a friend about the commercial (step 816), ordering the advertised product (step 818) or participating in other promotions (step 820).

Agency/Advertiser Functions

Referring back to FIG. 1, agencies and advertisers may connect to the system through the Internet la and interact with the system either anonymously, or as an authenticated agency. In a preferred embodiment, if they interact anonymously, they will have access only to online marketing literature about the system, and have the ability to register as an advertiser (210). After an agency or advertiser is registered with the system, it will be able to identify itself to the system whenever they return to the site through a sign-in process. The sign-in process preferably uses a standard browser “cookie” method of identifying the return of the agency, or, if the agency chooses not to use or enable cookies on their browser or is accessing the system from a different computer, a username and password is used to sign-in to the system.

The agencies and advertisers may use the system to place targeted, cost-effective video commercials, integrate the presentation of video commercials with interactive marketing programs (220), monitor and receive viewer feedback, in real-time, on a number of measurable parameters (e.g., effectiveness of commercials and programs, demographic makeup of the viewers) (240), review ratings, generate reports, and other functions. The agencies and advertisers will have the ability to control many aspects of the commercial programming, including having the ability to schedule specific commercials already pre-loaded into the system, set demographic restrictions and create special promotions.

Administration Functions

The system's administrators may access the system over the Internet or through a local computer system. In a preferred embodiment, administrative functions may include administrative services 310, commercial library maintenance 320, community management 330 and agency services 340. The administrative services 310 allow the administrators to maintain internal access control to the web site, enter and update specific content that appears on the web sites, and monitor and maintain other business-related aspects of the site. The commercial library maintenance 320 services allow the administrators to enter video commercials into the electronic library, set and monitor operational parameters related to the commercials, maintain an information facts library related to each commercial, keep track of the number of times a commercial is viewed, and other data pertinent to the usage of a commercial on the web site. The community management 330 services allow the administrators to manage functions related to viewers'membership information and status (such as proof of age), and to monitor and control the flow of email messages sent to viewers. The agency services 340 allow the administrators to manage functions related to the agency/advertiser, such as providing customer care communication and responses, and billing services.

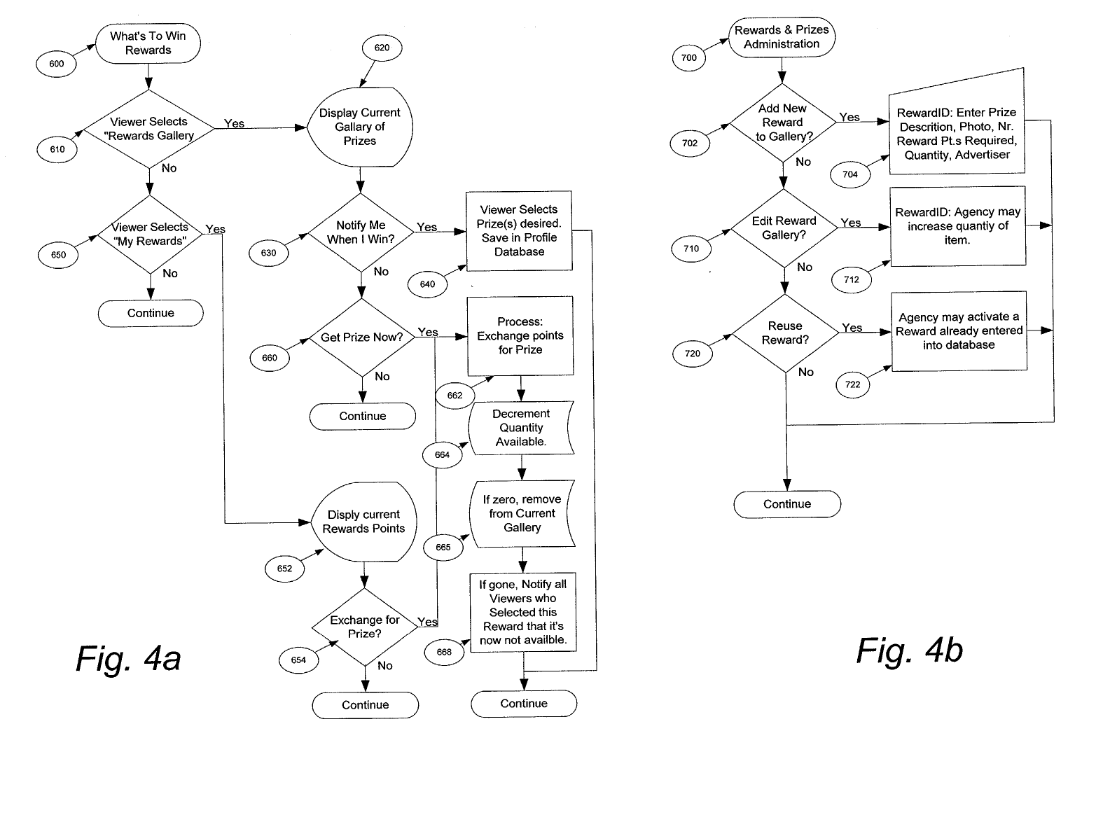

Rewards and prize administration is illustrated in FIG. 4b. The administrator may add new rewards to the rewards gallery in step 702. The rewards gallery is a listing of prizes that may be won or purchased by the viewer with the viewer's rewards points. If a new reward is added, the administrator may provide a description of the reward, a photo, the quantity available, the advertiser associated with the reward, and the number of points required to earn the prize (step 704). The administrator is also provide with the option to edit the reward gallery, e.g., to increase the quantity of the item that is available (steps 710 and 712), and to reactivate a reward that has already been entered into the rewards database (steps 720 and 722).

Rewards Points

A preferred embodiment of the manner in which a viewer selects and receives prizes is illustrated in flow diagram of FIG. 4a. The “What's To Win” selection (600) is a web page that permits the viewer to see a list of available prizes by selecting a “Rewards Gallery” link (610 & 620). The list of items may be organized by type or kind of prize, such as games, toys, sporting good, etc. or in any other manner. The viewer may also add any number of prizes to his profile database by selecting “Notify Me” (630) in step 640. Whenever the viewer earns rewards points, the system checks the viewer's profile and if the viewer has earned a sufficient number of points that may be exchanged for a prize that has been previously selected, the viewer is notified by both an email message and a pop-up window that appears on the viewer's web browser.

It is contemplated that the user may accumulate various types of points. In a preferred embodiment, the user may accumulate both general and specific points. General points are accumulated through the viewer's viewing and interacting with the interactive delivery system and may be redeemed for the current prizes that are available. In addition, advertisers may award specific points for the viewer's viewing and interacting with the advertiser's commercials. The advertiser may limit the prizes that are available for redemption using the specific points.

The viewer may see the number of rewards points accumulated by selecting “My Rewards” (650), which then displays the viewer's rewards points and other historical information (652). Should the viewer elect to exchange accumulated points for the desired prize (654, 660), the ordering processing function removes the item from “inventory” and provides instructions to ship the item to the viewer (steps 662-668). Other methods and processes of delivery may be implemented, and delivery of items may be verified by an independent auditing organization.

Each viewer may also be eligible to win sweepstakes prizes and other giveaways. In a preferred embodiment, prizes are awarded periodically to random viewers who are logged into the system as an incentive to keep viewers on the site. In addition, other prizes may be offered to attract viewers to certain promotions. For example, a prize may be awarded to a random viewer of a prime-channel commercial, to the one hundredth viewer of a commercial, or to one or more viewers based on some other criteria.

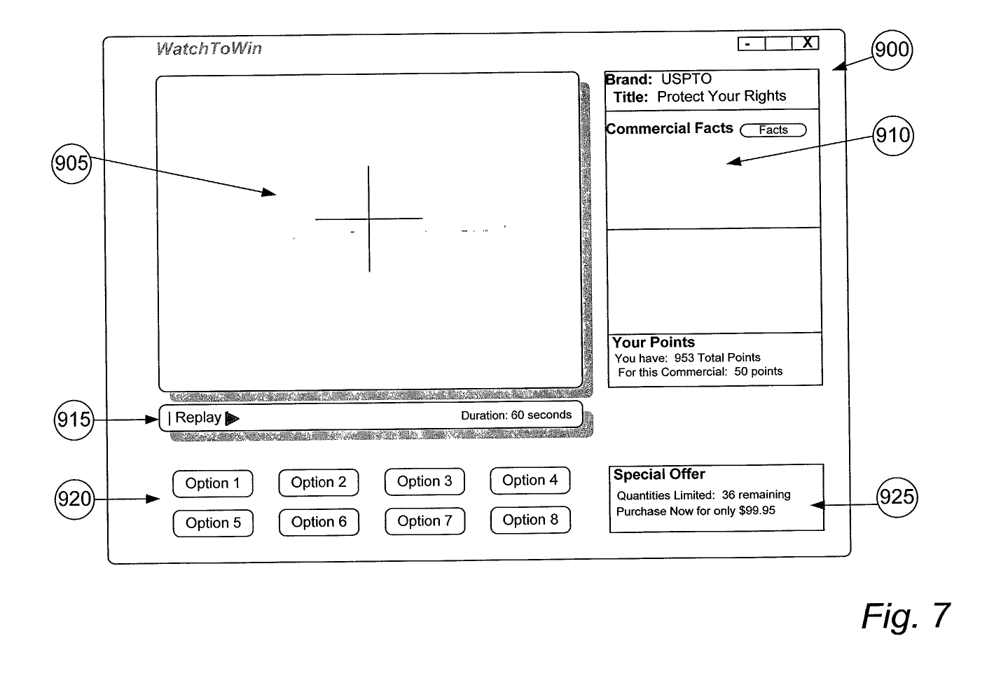

As one example of a preferred embodiment, the layout in FIG. 7 depicts a web page layout (900) that either may fill the entire screen of the viewer's computer monitor, or may be of smaller pixel size such that it functions as a pop-up window. The video commercial is presented to the viewer in the display area (905). Information about the commercial (910), including the advertisers name, title of commercial and “commercial facts” and other information regarding the points and rewards associated with a particular commercial are displayed. Video replay controls (915) allow the viewers to replay a commercial. The advertiser's desired interaction buttons (920), such as buy, get a coupon, download brochure, etc. are also displayed. Special information or offers may be presented in a window, such as window (925).

Having thus described a preferred embodiment of the Interactive Marketing and Advertising System and Method, it should be apparent to those skilled in the art that certain advantages of the within described system have been achieved. It should also be appreciated that various modifications, adaptations, and alternative embodiments thereof may be made within the scope and spirit of the present invention.

1. In a communications network having an interactive delivery system and at least one network device, a method for operating the interactive delivery system comprising the steps of:
receiving a request for a commercial from the network device;
transmitting the requested commercial to the network device;
transmitting interactive control information associated with the requested commercial to the network device, whereby the network device uses the interactive control information to present an interactive display to a user; and
receiving data describing the user's interaction with the interactive display.

2. The method of claim 1 wherein the commercial is a television commercial.

3. The method of claim 1 further comprising the steps of:
identifying the user; and
awarding at least one point to the user based on the user's interactions.

4. The method of claim 3 further comprising the step of:
maintaining a user profile, the user profile including user demographic information and personal preferences.

5. The method of claim 4 wherein the step of receiving a request further comprises the steps of:
retrieving the user's personal profile; and
generating a list of available commercials matching the user's personal profile; and
transmitting the generated list to the network device.

6. In a communications network having an interactive delivery system and at least one network device, a method for operating the network device comprising the steps of:
transmitting a request for a commercial to the interactive delivery system;
receiving the requested commercial from the interactive delivery system;
receiving interactive control information associated with the requested commercial;
creating an interactive display using the interactive control information;
displaying the requested commercial;
processing user interactions; and
transmitting data describing the user interactions to the interactive delivery system.

7. The method of claim 6 wherein the commercial is a television commercial.

8. The method of claim 6 wherein the interactive control information includes at least one control function having an associated point value.

9. The method of claim 6 wherein the step of transmitting a request further comprises the steps of:
receiving a list of available commercials from the interactive delivery system; and
displaying the list of available commercials for selection by the user.
